(19) United States
(12) Patent Application Publication
(10) Pub. No.: US 2007/0151557 A1
(43) Pub. Date: Jul. 5, 2007

(54) Chafing dish skirt

(75) Inventors: Robert McNelly, Incline Village, NV (US); Lisa McNelly, Incline Village, NV (US)

Correspondence Address: WOLF GREENFIELD & SACKS, P.C., 600 ATLANTIC AVENUE, BOSTON, MA, 02210-2206, US

(73) Assignee: Keep it Covered Inc, Incline Village, NV (US)

(21) Appl. No.: 11/646,100

(22) Filed: Dec. 27, 2006

Related U.S. Application Data
(60) Provisional application No. 60/756,320, filed on Jan. 4, 2006.

(51) Int. Cl. A47J 37/07; F24C 15/36

(52) U.S. Cl. 126/201; 126/9 R

(57) ABSTRACT

A chafing dish skirt that surrounds a chafing dish to keep the heat retained under the food pan and reduce the likelihood of wind from extinguishing the burners is provided. In some embodiments, the chafing dish skirt includes a length of elastic on a top portion and a length of elastic on a bottom portion to facilitate a relatively snug fit around the chafing dish. The skirt may be constructed to accommodate a range of various sizes and shapes of the chafing dish. The chafing dish skirt can have an access slit or passage that allows convenient access to the heat source, e.g., one or more burners, such that the heat source can be easily ignited and extinguished.

### CROSS-REFERENCE TO RELATED APPLICATION

This application claims the benefit of U.S. Provisional Patent Application Ser. No. 60/756,320, filed Jan. 4, 2006, which is hereby incorporated herein by reference.

### FIELD

The present disclosure relates to a skirt, and more particularly to a skirt for a chafing dish and method of use of the skirt to cover chafing dishes or other objects.

### BACKGROUND

Chafing dishes have long been used to keep food warm and typically include a food pan containing food, a frame supporting the dish, and one or more burners positioned underneath the dish. Chafing dishes are often used outdoors and are thus commonly exposed to various atmospheric conditions, such as wind and cool air. In such situations, wind often negatively effects the burners when lit and may even blow out the burners. Cooler air surrounding the burners dissipates heat intended for heating of food on the dishes.

### SUMMARY

According to one aspect of the invention, a chafing dish skirt is provided. The skirt has a flexible enclosure sized and formed to surround a lower portion of a chafing dish. The enclosure has an upper edge and a lower edge. An upper elastic strip is coupled to the enclosure adjacent the upper edge and a lower elastic strip is coupled to the enclosure adjacent the lower edge. The upper and lower elastic strips are configured to bias the corresponding upper and lower edges of the enclosure against the lower portion of the chafing dish when the chafing dish skirt is placed about the lower portion of the chafing dish.

According to another aspect of the invention, the chafing dish skirt has a flexible enclosure sized and formed to surround a lower portion of the chafing dish. The enclosure has an upper edge and a lower edge. The skirt has an upper elastic strip coupled to the enclosure adjacent the upper edge and a chafing dish opening defined by a perimeter of the upper edge of the enclosure. The opening is constructed and arranged to stretch to a perimeter ranging between approximately 45 inches and approximately 90 inches.

According to yet another aspect of the invention, the chafing dish skirt has an enclosure sized and formed to surround a lower portion of a chafing dish. The enclosure has an upper edge and a lower edge. The upper and lower edges having substantially the same perimeter. An access opening is formed through the enclosure. The access opening is sized and configured to allow access to a space surrounded by the chafing dish skirt when the chafing dish skirt is placed about the lower portion of the chafing dish.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1 is a side view of a chafing dish skirt turned inside-out, according to one exemplary embodiment.

FIG. 2 is a front view of a chafing dish skirt according to another exemplary embodiment.

FIG. 3 is a perspective view of several chafing dish skirts coupled to chafing dishes of various sizes and shapes.

FIG. 4 is a perspective view of a chafing dish skirt according to one exemplary embodiment having a frame.

### DETAILED DESCRIPTION

A chafing dish skirt that surrounds and is removably secured to a lower portion of a chafing dish to keep the heat retained under the food pan and reduce the likelihood of wind from extinguishing the burners is provided. In some embodiments, the chafing dish skirt includes a length of elastic on a top portion and a length of elastic on a bottom portion to facilitate a relatively snug fit around the chafing dish. The skirt may be constructed to accommodate a range of various sizes and shapes of the chafing dish. In certain embodiments, the chafing dish skirt is removably secured to the chafing dish by friction alone, without requiring use of weights or fastening structures to hold down or secure the lower end of the skirt below the food pan. In other embodiments, various fastening structures can be used.

In some embodiments, the chafing dish skirt can have an access slit or passage formed in the fabric that allows convenient access to the heat source, e.g., one or more burners, such that the heat source can be easily ignited, extinguished, repositioned etc.

The chafing dish skirt may also include ribs, providing greater structural stability. The material of the chafing dish skirt may be fire retardant.

By substantially enclosing the heat source space under the food pan with a chafing dish skirt of the type disclosed herein, the chances of wind extinguishing the heat source is substantially reduced and the heat retention below the food pan is significantly increased and food within the food pan is more efficiently heated.

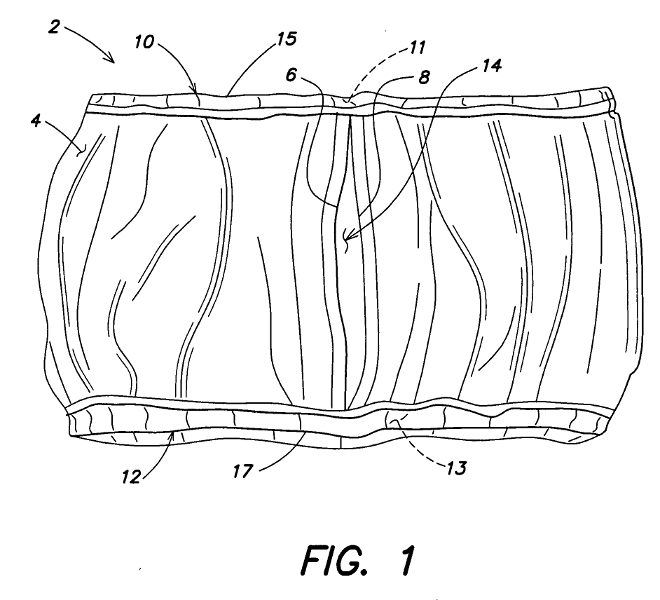

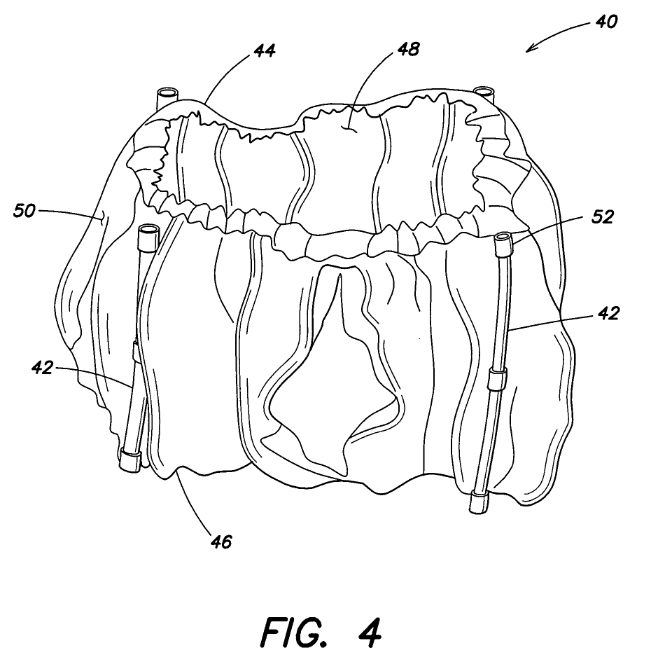

Referring to FIG. 1, according to one embodiment, a chafing dish skirt 2 includes a length of material 4 having first and second end portions 6, 8, respectively, coupled together to form an enclosure of an at least partially continuous ring or circle defined by an interiorly-facing side of the material. The enclosure has a chafing dish opening (see, e.g., 48 in FIG. 4). The chafing dish skirt 2 also includes a burner access opening 14 formed in the material 4 extending from a top portion 10 to a bottom portion 12 of the chafing dish skirt. In some implementations, the opening 14 is defined by coupling the end portions 6, 8 to each other at the top and bottom portions 10, 12, respectively, such that a length of the end portions 6, 8 are not coupled to each other to allow manual access to the burner or burners through the opening. It can be appreciated by those skilled in the art that providing such an axially extending burner access opening 14 allows the heat source to be lit, checked, extinguished or moved without requiring a complete removal of the skirt. Although in this embodiment, the access opening extends substantially vertically from top to bottom, other suitable configurations may be employed, as the present invention is not limited in this regard.

The material 4 may be made of a flexible fire-resistant fabric, such as one hundred percent polyester FR. In one specific embodiment, the fabric is Avora®FR, made by Invista of Wichita, Kans. In other specific embodiments, the fabric is Nomex®, made by DuPont, Inc. of Wilmington, Del. Inherently fire-resistant fabric provides particular advantages, for example, it helps reduce, and may even eliminate, a need for re-treatment of the material with fire-resistant coatings since the fire-resistant characteristics of the fiber do not substantially deplete over time. Further, fire-resistant fabric can be machine-washed and tumble-dried or dry-cleaned without relinquishing the fire-resistant capabilities of the fabric. However, if desirable, in some applications, the material 4 can be any material having a fire-resistant coating applied thereon.

An elastic material formed as an elastic strip can be coupled to and extend at least partially along the top and/or bottom portions 10, 12, respectively. The elastic material can be stretched or expanded to enlarge the chafing dish opening. Further the elastic material is an at least partially resilient material such that when not stretched, it can return to its approximately original shape. In some implementations, the top and bottom portions 10, 12 include overlapping portions of material 4 that define passageways 11, 13, respectively, between the overlapping portions. The passageways 11, 13 have a generally elongate ovular-shaped cross-section and are coextensive with the material 4 forming top and bottom edges 15, 17 of the top and bottom portions 10, 12, respectively. Each length of elastic material can be disposed within the passageways 11, 13, respectively, and be at least partially coupled to one of the overlapping portions of material 4. Other suitable attachment arrangements for coupling the elastic material to the body of the cover can be employed, as the present invention is not limited in this regard.

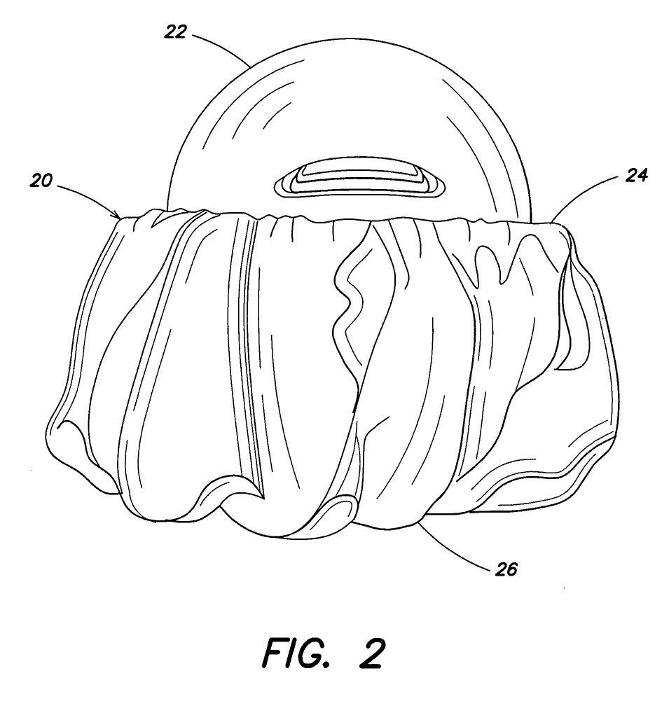

As can be recognized, the chafing dish opening can be selectively expanded by stretching the elastic material along the top and bottom portions such that the opening is just larger than a chafing dish or frame to be skirted. While the elastic is thus stretched, a chafing dish skirt, e.g., chafing dish skirt 20, can be positioned around a chafing dish, e.g., chafing dish 22 to be shielded (see FIG. 2). Since the elastic is resilient, when the elastic material along the top portion and bottom portion is taken out of tension or released, it constricts to sealably contact, i.e., apply a radially inwardly directed pressure against, the chafing dish. In this manner, the chafing dish skirt, e.g., chafing dish skirt 2, 20, can be removably secured to the chafing dish.

Further, the elastic material in the relaxed state can be shorter in length than the material, as will be described in more detail below, thus causing the material to attractively bulge, fold on itself, and/or gather as shown in FIGS. 1-4. The applicants have discovered that gathering the material in this fashion, as opposed to providing flat or pleated material, provides better wind resistance and heat retention due to the layering of material surrounding the chafing dish when coupled to a chafing dish.

As can be recognized, in some implementations, the chafing dish skirt of the present application does not necessarily require additional attachment or weighting mechanisms. However, in some applications, strings, ropes, Velcro straps, or fire-resistant ties can be coupled to the material 4 to further secure the chafing dish skirt to a chafing dish. Also, the area of the material facing the chafing dish may include a tacky material to aid in holding the skirt against the chafing dish.

Exemplary of a chafing dish skirt of the present disclosure, chafing dish skirt 20 of FIG. 2, can shield a chafing dish 22 by positioning the top portion 24 of the chafing dish skirt 20 around the chafing dish frame just above or below a chafing dish frame handle (not shown) and a bottom portion 26 can be extended around the exterior of a bottom portion of the chafing dish frame legs or underneath the frame legs. Providing an elastic material around the bottom portion 12 of the skirt 2 and positioning the bottom portion 12 at or near a surface supporting the chafing dish increases the resistance to wind and results in a more efficient retention of heat underneath the chafing dish pan. In some applications using multiple heat sources or burners for a single chafing dish, the elastic material on the top and bottom portions 10, 12 can allow for the elimination of one of the heat sources without sacrificing performance.

In an exemplary method of making the chafing dish skirt 2 of FIG. 1, an elongate length of fire-resistant fabric can be cut to any of various lengths and widths. In one specific exemplary embodiment, the length can be approximately 126 inches long and approximately 18 inches wide. All four edges of the fabric can be finished by sewing the edges with a serger stitch or lock-over stitch. The edges extending the width of the fabric, e.g., the two 18-inch edges in the specific example, can be turned under and sewn to an underlying portion of the fabric using a finishing seam, such as an approximately ¾ inch finishing seam, to form the first and second end portions 6, 8. The first and second end portions 6, 8 are positioned adjacent each other and the top and bottom edges, e.g., the 126-inch edges in the specific example, of the respective first and second end portions 6, 8 are sewn together with a seam extending a distance, e.g., approximately 1½ inches, from the top and bottom of the skirt 2, respectively. In this manner, the portions of the end portions 6, 8 not sewn together define the opening 14, which, in the exemplary embodiment, can be an approximately 14 inch long opening.

This method of making the chafing dish skirt further includes cutting 2 pieces of elastic, such as ¾-inch elastic, each having a length less than the length of the fabric. For example, in the specific embodiment, the length of each piece of elastic can be approximately 45 inches. At the seam junction between the first and second end portions 6, 8, a first end of each length of elastic is sewn to the fabric, e.g., at a location approximately one inch away from edges extending the length of the fabric, e.g., the 126-inch edges in the specific example. At approximately midway between the first and second end portions 6, 8, the elastic is tacked to the fabric, e.g., at a location approximately one inch away from the edges extending the length of the fabric, respectively, to facilitate even distribution of the elastic along the fabric. The top and bottom portions 10, 12 are formed by turning the edges extending the length of the fabric inward over the elastic to effectively encase the elastic. The edges of the fabric extending the length of the fabric are then sewn to the underlying fabric with a finishing stitch.

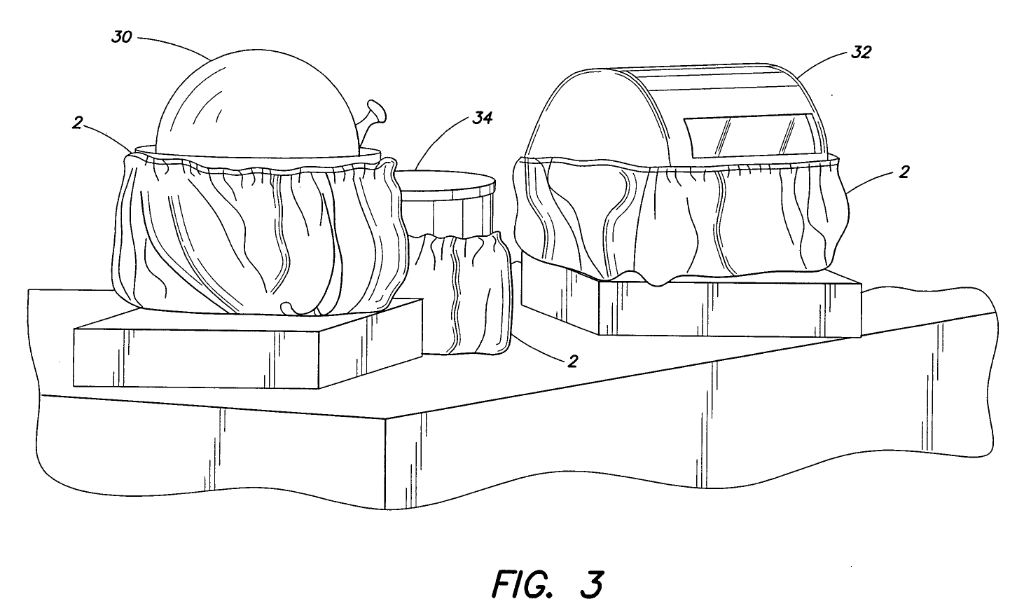

The chafing dish skirt 2 is configured to adapt to, embrace and shield, or skirt, chafing dishes of various shapes, such as circular, ovular, rectangular, or other shapes. In one specific example, chafing dish skirt 2 can embrace and skirt chafing dishes having a circumference or periphery between about 45 inches and 90 inches. As can be recognized, a single chafing dish skirt, e.g., chafing dish skirt 2, can be used to shield or skirt any number of chafing dishes having various sizes and shapes, e.g., chafing dishes 30, 32 (see FIG. 3). In other words, the chafing dish skirt can be interchangeable with any number of chafing dishes and separate chafing dish skirts specifically sized for specifically-sized chafing dishes are not necessary.

Alternatively, in some implementations, a chafing dish skirt 2 can be placed around containers other than a chafing dish. For example, as shown in FIG. 3, a chafing dish skirt 2 is placed around a food container 34. In specific implementations, the containers can be, for example, garbage cans, ice buckets, crock stands and bain-maries.

In an alternative exemplary embodiment shown in FIG. 4, a chafing dish skirt 40 can include one or more ribbing elements 42 coupled to the fabric and extending from a top portion 44 to a bottom portion 46 of the skirt. The ribbing elements 42 can be at least partially rigid plastic rods or bendable wires to provide added structural rigidity to the chafing dish skirt 40 and to retain spacing between the top and bottom portions 10, 12 as shown in FIG. 1. Further the ribbing elements 42 can secure the skirt material 50 in position outwardly from the underside of chafing dish frame (not shown) and the heat source. The ribbing elements 42 thus can further prevent contact between the skirt material and the heat source, such as when wind urges the material inwardly toward the heat source.

In the illustrated embodiment, chafing dish skirt 40 includes four tubular ribs 42 secured to the to the material 50 along its axial length (from the top edge to the bottom edge of the skirt 40) by fastening structure such as three Velcro straps, with one exemplary strap indicated at 52 and axially extending along the length of the skirt from the upper end to the lower end of the skirt 40. In other embodiments, the ribbing elements 42 can be attached by fewer or more than three Velcro straps, or by other attachment mechanisms. Further, the chafing dish skirt can include fewer or more ribs as desired. In the illustrated embodiment, the tubular ribs 42 are made of plastic or metal, non-flammable flexible, rods, but they could alternatively be made of a variety of other relatively resilient and rigid materials.

As can be recognized from the foregoing, certain embodiments of the chafing dish skirts provide a useful wind block and heat retainer while providing an inexpensive, decorative solution to use of chafing dishes and other containers. Further, the chafing dish skirt of the present application is lightweight, easy to store and manufacture, and inexpensive.

In view of the many possible embodiments to which the principles of the disclosed invention may be applied, it should be recognized that the illustrated embodiments are only preferred examples of the invention and should not be taken as limiting the scope of the invention.

Having thus described several aspects of at least one embodiment of this invention, it is to be appreciated various alterations, modifications, and improvements will readily occur to those skilled in the art. Such alterations, modification, and improvements are intended to be part of this disclosure, and are intended to be within the spirit and scope of the invention. Accordingly, the description and drawings herein are by way of example only.

What is claimed is:

1. A chafing dish skirt comprising:
a flexible enclosure sized and formed to surround a lower portion of a chafing dish, the enclosure having an upper edge and a lower edge;
an upper elastic strip coupled to the enclosure adjacent the upper edge; and
a lower elastic strip coupled to the enclosure adjacent the lower edge;
wherein the upper and lower elastic strips are configured to bias the corresponding upper and lower edges of the enclosure against the lower portion of the chafing dish when the chafing dish skirt is placed about the lower portion of the chafing dish.

2. The skirt according to claim 1, wherein the upper edge includes an upper passageway, with the upper elastic strip disposed within the upper passageway and wherein the lower edge includes a lower passageway, with the lower elastic strip disposed within the lower passageway.

3. The skirt according to claim 1, wherein the upper edge has an upper edge length and wherein the upper elastic strip has an upper strip length that, in a relaxed state, is less than the upper edge length and wherein lower edge has a lower edge length and wherein the lower elastic strip has a lower strip length that, in a relaxed state, is less than the lower edge length.

4. The skirt according to claim 1, wherein the enclosure comprises a layer of material having first and second side edges extending between the upper and lower edges, the side edges joined, at least partially, to each other to form the enclosure, wherein at least one of the upper elastic strip and the lower elastic strip is attached to the layer of material at a location approximately midway between the first and second side edges.

5. The skirt according to claim 1, further comprising a plurality of stiffening ribs coupled to the enclosure, the stiffening ribs constructed and arranged to bias at least portions of the enclosure away from the lower portion of the chafing dish when the chafing dish skirt is placed about the lower portion of the chafing dish.

6. The skirt according to claim 1, wherein the enclosure is formed of a fire resistant material or comprises a fire resistant coating.

7. The skirt according to claim 1, further comprising a chafing dish opening defined by a perimeter of the upper edge of the enclosure, wherein the opening is constructed and arranged to stretch to a perimeter ranging between approximately 45 inches and approximately 90 inches.

8. The skirt according to claim 1, further comprising an access opening formed through the enclosure, the access opening sized and configured to allow access to a space surrounded by the chafing dish skirt when the chafing dish skirt is placed about the lower portion of the chafing dish.

9. A chafing dish skirt comprising:
a flexible enclosure sized and formed to surround a lower portion of a chafing dish, the enclosure having an upper edge and a lower edge;
an upper elastic strip coupled to the enclosure adjacent the upper edge; and
a chafing dish opening defined by a perimeter of the upper edge of the enclosure, wherein the opening is constructed and arranged to stretch to a perimeter ranging between approximately 45 inches and approximately 90 inches.

10. The skirt according to claim 9, wherein a length of the upper edge is approximately 126 inches, whereby the upper elastic strip gathers the upper edge so that the chafing dish opening can stretch or contract to the perimeter ranging between approximately 45 inches and approximately 90 inches and wherein a height of the enclosure defined between the upper and lower edges is approximately 18 inches.

11. The skirt according to claim 9, further comprising a fastening means for facilitating holding the enclosure to the lower portion of the chafing dish.

12. The skirt according to claim 9, further comprising a plurality of stiffening ribs coupled to the enclosure, the stiffening ribs constructed and arranged to bias at least portions of the enclosure away from the lower portion of the chafing dish when the chafing dish skirt is placed about the lower portion of the chafing dish.

13. The skirt according to claim 9, wherein the enclosure is formed of a fire resistant material or comprises a fire resistant coating.

14. The skirt according to claim 9, further comprising an access opening formed through the enclosure, the access opening sized and configured to allow access to a space surrounded by the chafing dish skirt when the chafing dish skirt is placed about the lower portion of the chafing dish.

15. A chafing dish skirt comprising:
an enclosure sized and formed to surround a lower portion of a chafing dish, the enclosure having an upper edge and a lower edge, the upper and lower edges having substantially the same perimeter; and
an access opening formed through the enclosure, the access opening sized and configured to allow access to a space surrounded by the chafing dish skirt when the chafing dish skirt is placed about the lower portion of the chafing dish.

16. The skirt according to claim 15, wherein the access opening extends in a substantially vertical orientation between the upper and lower edges and wherein the access opening is approximately 14 inches in length.

17. The skirt according to claim 15, wherein the enclosure comprises first and second side edges extending between the upper and lower edges, the side edges joined, at least partially, to each other to form the enclosure, wherein the access opening is formed between the first and second side edges.

18. The skirt according to claim 15, further comprising a fastening means for facilitating holding the enclosure to the lower portion of the chafing dish.

19. The skirt according to claim 15, further comprising a plurality of stiffening ribs coupled to the enclosure, the stiffening ribs constructed and arranged to bias at least portions of the enclosure away from the lower portion of the chafing dish when the chafing dish skirt is placed about the lower portion of the chafing dish.

20. The skirt according to claim 15, wherein the enclosure is formed of a fire resistant material or comprises a fire resistant coating.
